(19) United States
(12) Patent Application Publication
(10) Pub. No.: US 2019/0259071 A1
(43) Pub. Date: Aug. 22, 2019

(54) PROPERTY INFORMATION PROCESSING METHOD AND APPARATUS, COMPUTER DEVICE AND STORAGE MEDIUM

(71) Applicant: PING AN TECHNOLOGY(SHENZHEN)CO.,LTD., Shenzhen (CN)

(72) Inventors: Jianzong WANG, Shenzhen (CN); Zhangcheng HUANG, Shenzhen (CN); Tianbo WU, Shenzhen (CN); Jing XIAO, Shenzhen (CN)

(21) Appl. No.: 16/313,793

(22) PCT Filed: Jun. 28, 2017
(86) PCT No.: PCT/CN2017/090580

§ 371 Date: Dec. 27, 2018

(30) Foreign Application Priority Data
May 10, 2017 (CN) 201710326478.7

(51) Int. Cl. G06Q 30/02; G06Q 50/16

(52) U.S. Cl. CPC G06Q 30/0278; G06Q 50/16

(57) ABSTRACT

A method for processing real estate information comprises steps of: acquiring a target geographical location corresponding to real estate information to be appraised; acquiring all configuration information within a preset range around the target geographical location; determining a score corresponding to each piece of configuration information according to a preset scoring standard; obtaining a standardized eigenvalue by projecting the score determined according to a distance between each piece of configuration information and the target geographical location; and determining an appraised price of a real estate corresponding to the target geographical location by using a real estate price appraisal model according to the standardized eigenvalue

This application is a U.S. National Stage Application of PCT International Application No. PCT/CN2017/090580 filed on Jun. 28, 2017, which claims priority to China Patent Application No. 201710326478.7 titled “Method and Device for Processing Real Estate Information, Computer Device and Storage Medium” and submitted to the State Intellectual Property Office of China on May 10, 2017, the contents of each of the foregoing applications are hereby incorporated by reference.

### TECHNICAL FIELD

The present disclosure relates to the technical field of computer processing, and particularly to a method and a device for processing real estate information, a computer device, and a storage medium.

### BACKGROUND

Real estate finance is becoming prosperous with the development of economy. An accurate real estate price appraisal is very important for the development and investment of the real estate finance. A professional person, who has Post Qualification Certificate of Real Estate Appraiser or Real Estate Appraiser Registration Certificate, is usually required to appraise, predict, and judge the most possible reasonable price of the real estate according to the appraisal purpose, following the appraisal principle, in accordance with the appraisal procedure, using the appraisal method, based on the comprehensive analysis of factors that affect the price of the real estate, and in combination with the appraisal experience and the analysis of the factors that affect the price of the real estate. However, by employing the professional person to appraise the price, not only time and labor are consumed, but the price usually cannot be accurately appraised due to individual cognitive biases.

### SUMMARY

According to various embodiments of the present invention, a method and a device for processing real estate information, a computer device, and a storage medium are provided.

A method for processing real estate information comprises steps of:

acquiring a target geographical location corresponding to real estate information to be appraised;

acquiring all configuration information within a preset range around the target geographical location;

determining a score corresponding to each piece of configuration information according to a preset scoring standard;

obtaining a standardized eigenvalue by projecting the score determined according to a distance between a facility corresponding to each piece of configuration information and the target geographical location; and

determining an appraised price of a real estate corresponding to the target geographical location by using a real estate price appraisal model according to the standardized eigenvalue.

A device for processing real estate information comprises:

a geographical location acquiring module, configured to acquire a target geographical location corresponding to the real estate information to be appraised;

a configuration information acquiring module, configured to acquire all configuration information within a preset range around the target geographical location;

a score determining module, configured to determine a score corresponding to each piece of configuration information according to a preset scoring standard;

a standardized eigenvalue determining module, configured to obtain a standardized eigenvalue by projecting the score determined according to a distance between a facility corresponding to each piece of configuration information and the target geographical location; and

a real estate price determining module, configured to determine an appraised price of a real estate corresponding to the target geographical location by using a real estate price appraisal model according to the standardized eigenvalue.

A computer device comprises a memory and a processor, wherein the memory has computer readable instructions stored thereon, when the computer readable instructions are executed by the processor, following steps are implemented:

acquiring a target geographical location corresponding to the real estate information to be appraised;

acquiring all configuration information within a preset range around the target geographical location;

determining a score corresponding to each piece of configuration information according to the preset scoring standard;

obtaining a standardized eigenvalue by projecting the score determined according to a distance between a facility corresponding to each piece of configuration information and the target geographical location; and

determining an appraised price of a real estate corresponding to the target geographical location by using a real estate price appraisal model according to the standardized eigenvalue.

One or more non-volatile computer readable storage media have computer readable instructions stored thereon, wherein when the computer readable instructions are executed by one or more processors, following steps are implemented:

acquiring a target geographical location corresponding to the real estate information to be appraised;

acquiring all configuration information within a preset range around the target geographical location;

determining a score corresponding to each piece of configuration information according to the preset scoring standard;

obtaining a standardized eigenvalue by projecting the score determined according to a distance between a facility corresponding to each piece of configuration information and the target geographical location; and

determining an appraised price of a real estate corresponding to the target geographical location by using a real estate price appraisal model according to the standardized eigenvalue.

Details of one or more embodiments of the present invention are provided below in the accompanying drawings and descriptions. Other features, objectives, and advantages of the present disclosure will become apparent with reference to the specification, the accompanying drawings, and the claims.

### BRIEF DESCRIPTION OF THE DRAWINGS

To describe the technical solutions of the embodiments of the present invention more clearly, the accompanying drawings required for describing the embodiments will be briefly described. Apparently, the accompanying drawings in the following description show only some embodiments of the present invention, and a person of ordinary skill in the art may still derive other drawings from these accompanying drawings without creative efforts.

FIG. 1 is a block diagram of an internal structure of a terminal according to one embodiment.

FIG. 2 is a block diagram of an internal structure of a server according to one embodiment.

FIG. 3 is a flow chart of a method for processing real estate information according to one embodiment.

FIG. 4 is a flow chart of a method for establishing a real estate price appraisal model according to one embodiment.

FIG. 5 is a flow chart of a method for obtaining a standardized eigenvalue by projecting a score determined according to one embodiment.

FIG. 6 is a flow chart of a method for determining an appraised price of a real estate corresponding to a target geographical location by using the real estate price appraisal model based on the standardized eigenvalue according to one embodiment.

FIG. 7 is a flow chart of a method for determining a score corresponding to each piece of configuration information based on a preset scoring standard according to one embodiment;

FIG. 8 is a block diagram of a structure of a device for processing real estate information according to one embodiment.

FIG. 9 is a block diagram of the structure of the device for processing real estate information according to another embodiment.

FIG. 10 is a block diagram of a structure of a real estate price determining module according to one embodiment.

### DETAILED DESCRIPTION

For a clear understanding of the technical features, objects and effects of the present disclosure, specific embodiments of the present invention will now be described in detail with reference to the accompanying drawings. It is to be understood that the following description is merely exemplary embodiments of the present invention, and is not intended to limit the scope of the present disclosure.

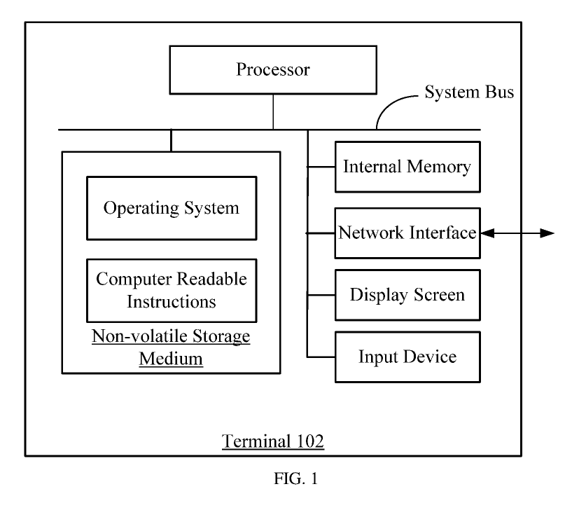

In one embodiment, an internal structure of a terminal 102 is shown in FIG. 1, which includes a processor, an internal memory, a non-volatile storage medium, a network interface, a display screen, and an input device which are connected through a system bus. Wherein an operating system and computer readable instructions are stored in the non-volatile storage medium of the terminal 102. The computer readable instructions can be executed by the processor to implement a method for processing real estate information applicable to the terminal 102. The processor is configured to provide computing and controlling capabilities to support the operation of the entire terminal 102. The internal memory of the terminal 102 is configured to provide an operation environment for the operating system and the computer readable instructions in the non-volatile storage medium. The network interface is configured to be connected to the network for communication. The display screen of the terminal 102 can be such as a liquid crystal display screen or an electronic ink display screen. The input device can be a touch panel covered on the display screen; a button, a trackball, or a touchpad provided on a housing of an electronic device; or an external keyboard, a touchpad, or a mouse. The terminal can be a tablet computer, a laptop computer, a desktop computer and so on. It can be understood that the structure as shown in FIG. 1 is a block diagram simply showing the parts in the terminal that are related to the present disclosure, and does not constitute a limitation on the terminal which the present disclosure can be applied to. The specific terminal can include more or fewer parts compared with that shown in the drawings, or can be in combination with certain parts, or can have different parts.

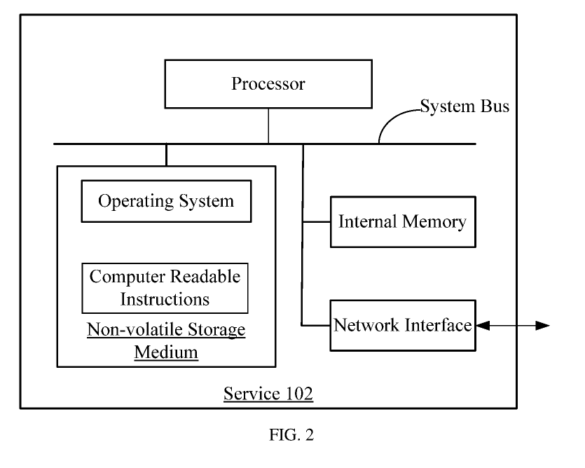

Referring to FIG. 2, in one embodiment, an internal structure of a server 104 is shown in FIG. 2, which includes a processor, a non-volatile storage medium, an internal memory, and a network interface which are connected through a system bus. Wherein the non-volatile storage medium includes an operating system and computer readable instructions. The computer readable instructions can be executed by the processor to implement a method for processing real estate information applicable to the server 104. The processor of the server is configured to provide computing and controlling capabilities to support the operation of the entire server. The internal memory of the server is configured to provide an operation environment for the operating system and the computer readable instructions in the non-volatile storage medium. The network interface of the server is configured to be connected to the network for communication. It can be understood that the structure shown in FIG. 2 is a block diagram simply showing the parts in the server that are related to the present disclosure, and does not constitute a limitation on the server which the present disclosure can be applied to. The specific server can include more or fewer parts compared with that shown in the drawings, or can be in combination with certain parts, or can have different parts.

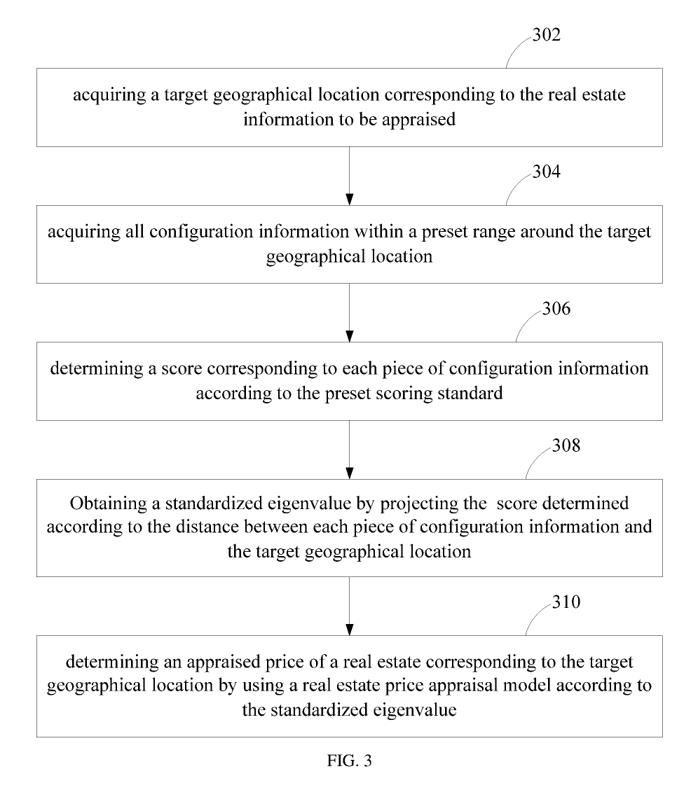

Referring to FIG. 3, in one embodiment, a method for processing real estate information applicable to the terminal or the server is provided, which includes steps of:

Step 302, acquiring a target geographical location corresponding to the real estate information to be appraised.

In the present embodiment, the target geographical location refers to a location of the real estate information to be appraised. The target geographical location is indicated by using latitude-longitude values. Since average transaction prices (i.e. a transaction prices per unit area) of some houses and housing estates cannot be acquired directly, the average transaction prices of real estate which cannot be directly acquired needs to be appraised. The average transaction price of the real estate is closely related to the geographical location of the real estate. The average transaction price refers to a transaction price per unit area, which is also a transaction price per square meter. In order to appraise unknown real estate price information, the target geographical location corresponding to the real estate information to be appraised needs to be acquired firstly. The target geographical location of the real estate is fixed. Latitude-longitude information of the real estate can be acquired by conventional location techniques.

Step 304, acquiring all configuration information within a preset range around the target geographical location.

In the present embodiment, except for the target geographical location, the factors that affect the price of the houses also includes configuration facilities such as hospitals and schools around the house. Therefore, except for the target geographical location of the real estate to be appraised, all configuration information around the target geographical location should be acquired. The configuration information includes life factors affecting the real estate price, such as schools, hospitals, markets, transportations, scenic spots, hotels, and so on. The influence of the configuration information around the house is related to distance. The influence of the configuration information can be neglected if it is too far away from the house. Therefore, only configuration information within the preset range (such as 2000 meters) is needed.

Step 306, determining a score corresponding to each piece of configuration information according to a preset scoring standard.

In the present embodiment, after all configuration information within the preset range around the real estate is acquired, in order to quantify an influence extent of each piece of configuration information to the real estate price, the score corresponding to each piece of configuration information needs to be determined according to the preset scoring standard. The scoring standards of different classes of configuration information are different. For example, with respect to schools, the score can be determined according to primary school, secondary school, and local rankings thereof. With respect to hospitals, the score can be determined to hospital level, such as Grade-A Tertiary hospital, Grade-A Secondary hospital, and the like. More specially, attribute information corresponding to each piece of configuration information is acquired at first. The attribute information refers to a class that the configuration information belongs to, such as schools, hospitals, transportation facilities, or other classes. The configuration information is previously classified according to the attribute information, and then the scoring standards corresponding to different classes of configuration information can be set, that is, different attribute information corresponds to different scoring standards. Therefore, after the attribute information corresponding to each piece of configuration information is acquired, the scoring standard corresponding to each piece of configuration information can be acquired according to the attribute information, and the score corresponding to each piece of configuration information can be determined according to the scoring standard. In one embodiment, when the configuration information is a hospital, and the scoring standard to hospitals is determined by the hospital level, if the hospital is a Grade-A Tertiary hospital, then the corresponding score can be set as 3; if the hospital is a Grade-A Secondary hospital, then the corresponding score can be set as 2.

Step 308, obtaining a standardized eigenvalue by projecting the score determined according to a distance between a facility corresponding to each piece of configuration information and the target geographical location.

In the present embodiment, the influence extent of the configuration information to the real estate is related not only to the configuration information itself, but to the distance between the facility corresponding to the configuration information and the real estate. That is, facilities corresponding to the same configuration information located at different distances have different influence extents. Therefore, after the score corresponding to each piece of configuration information is acquired, the score calculated needs to be further projected according to the distance between each piece of configuration information and the target geographical location of the real estate, thereby obtaining the standardized eigenvalue. The standardized eigenvalue is used as a basis to appraise the real estate price in the subsequent corresponding real estate price appraisal. More specially, attribute values of the configuration information are projected together to values ranged from 0 to 1 according to distances of facilities corresponding to the configuration information, and then the score determined is multiplied by the corresponding attribute value to obtain the standardized eigenvalue. That is, a coefficient factor related to distance is provided for each piece of configuration information, and the score obtained is standardized uniformly by multiplying with the coefficient factor, so that an influence weight of each piece of configuration information is determined more accurately in the subsequent steps. In one embodiment, coefficient factors corresponding to different distances can be set, for example, a coefficient factor corresponding to a distance ranged from 0 mm to 100 mm can be set as 1, a coefficient factor corresponding to a distance ranged from 100 mm to 200 mm can be set as 0.9, a coefficient factor corresponding to a distance ranged from 200 mm to 500 mm can be set as 0.8. Greater the distance, smaller the corresponding coefficient factor. The corresponding coefficient factor can be flexibly set according to the actual condition. In one embodiment, if a score of a Grade-A Tertiary hospital within a range of 200 mm away from a house is 3, and a score of a Grade-A Secondary hospital within a range of 500 mm away from the house is 2, then the corresponding standardized eigenvalues are respectively 3*0.9 and 2*0.8.

In another embodiment, sigmoid function can be used as one coefficient factor of distance:

$$coef = \frac{1}{1 + exp ( \frac{x - d \text{/} 2}{d \text{/} τ} )} ,$$

wherein x denotes the distance between the facility corresponding to the configuration information and the target geographical location, and d denotes a preset distance range, such as d=1000 m. An attenuation degree of the coefficient factor with respect to the distance is decided by τ. The greater τ is, the slower the coefficient factor attenuates. For example, τ=20. The scores corresponding to the configuration information can be projected through the above equation to obtain the standardized eigenvalue. In one embodiment, if a score of a Grade-A Tertiary hospital at 1000 meters away from a house is 3, and a score of a Grade-A Secondary hospital at 800 meters away from the house is 2, d is set as 1500 m, and τ=20, then the corresponding scores after the standardization are respectively

$$\frac{3}{1 + exp ( \frac{1000 - 1500 \text{/} 2}{1500 \text{/} 20} )} and \frac{2}{1 + exp ( \frac{800 - 1500 \text{/} 2}{1500 \text{/} 20} )} .$$

Step 310, determining an appraised price of a real estate corresponding to the target geographical location by using a real estate price appraisal model according to the standardized eigenvalue.

In the present embodiment, after the standardized eigenvalue is obtained according to the distance between the facility corresponding to each piece of configuration information and the target geographical location, a previously established real estate price appraisal model is used to calculate and obtain the appraised price of the real estate corresponding to the target geographical location according to the standardized eigenvalue. The real estate price appraisal model is previously trained and obtained according to acquired known prices of real estate and standardized eigenvalues corresponding to configuration information around the above real estate. Therefore, the real estate price can be appraised according to the standardized eigenvalue corresponding to the configuration information around the real estate.

In the present embodiment, by acquiring the target geographical location corresponding to the real estate information to be appraised, all configuration information within the preset range around the target geographical location is acquired, the score corresponding to each piece of configuration information is determined according to the preset scoring standard, the score determined is projected according to the distance between the facility corresponding to each piece of configuration information and the target geographical location to obtain the standardized eigenvalue, and the appraised price of the real estate corresponding to the target geographical location is determined according to the standardized eigenvalue by using the real estate price appraisal model. In the above described method for processing the real estate information, the real estate price can be automatically appraised according to the geographical location of the real estate and the configuration information around the geographical location by using the established real estate price appraisal model. Compared to the conventional method to appraise the real estate price by professional appraisers, the method of the present disclosure saves time and labor, in addition, because that the real estate price appraisal model is established based on big date, the bias resulting from manual appraisal is decreased, which is beneficial to improve the accuracy of the appraisal.

In one embodiment, before the step of acquiring a target geographical location corresponding to the real estate information to be appraised, the method further includes a step of establishing the real estate price appraisal model.

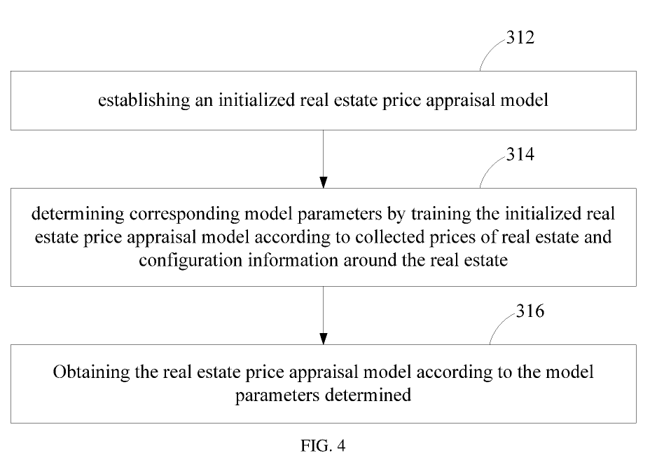

Referring to FIG. 4, the step of establishing the real estate price appraisal model specially includes steps of:

Step 312, establishing an initialized real estate price appraisal model.

In the present embodiment, considering that the real estate price information is not only related to the geographical location of the real estate, but closely related to the configuration facilities around the real estate, in order to be able to appraise the price information of the real estate automatically according to the geographical location of the real estate and the configuration information around the real estate, the initialized real estate price appraisal model needs to be firstly established. Since the configuration information around the real estate is all used to improve life quality of people, it can be hypothesized that the coefficient factor of each piece of configuration information is positively correlated with the real estate price. In one embodiment, a simple linear regression model can be used as the initialized real estate price appraisal model:

Y=β₀+β₁X₁+β₂X₂+ . . . +βₙXₙ

wherein X₁, X₂, X₃, . . . , Xₙ respectively denotes the eigenvalue corresponding to each piece of configuration information, Y denotes the corresponding appraised price of the real estate. After the initialized real estate price appraisal model is established, the linear regression model needs to be trained to learn to obtain a coefficient value corresponding to each piece of configuration information, i.e. values of β₀, β₁, β₂, . . . , βₙ.

Step 314, training the initialized real estate price appraisal model according to collected prices of real estate and configuration information around the real estate.

In the present embodiment, after the initialized real estate price appraisal model is established, a training set for training the initialized real estate price appraisal model should be established. Real estate data of the collected prices of the real estate and the configuration information around the real estate is used as the training set. The score corresponding to each piece of configuration information is respectively determined according to the preset scoring standard. The score determined is standardized according to distance to obtain corresponding eigenvalue. The initialized real estate price appraisal model is trained by using machine learning algorithm according to the eigenvalue corresponding to the configuration information and the corresponding known information of real estate price, so as to obtain the corresponding coefficient value. The machine learning algorithm can be a least square method, a gradient descent method, and the like.

It is easy to cause an over-fitting phenomenon if all collected data is been learned. Therefore, in one embodiment, a cross validation should be considered during the training to the model. The cross validation is a practical statistics method to partition a data sample into smaller subsets. One subset can be analyzed at first, and other subsets can be subsequently used to confirm and verify the above analysis. The subset to be analyzed at first can be referred to as the training set, and other subsets can be referred to as verifying sets or testing sets. The purpose of the cross validation is to define a data set into the tested model, thereby decreasing the over-fitting phenomenon in the training stage.

In one embodiment, all collected data space can be defined as p=(χ, y) at first, wherein x=(X₁, X₂, X₃ . . . ) denotes characteristic space of collected data, wherein each Xᵢ corresponds to a data point and y denotes a real value of each house and real estate. It should be noted that Xᵢ={xᵢ₁, xᵢ₂, xᵢ₃ . . . }, wherein each xᵢⱼ denotes one characteristic. The value corresponding to each characteristic is related not only to the characteristic itself, but to the distance between the characteristic and the house. The established initial real estate price appraisal model is trained by using the data in the collected data space, thereby determining the final real estate price appraisal model. More specifically, the target of the model can be set as

$${min}_{w} {‖ Xw - y ‖}_{2}^{2} ,$$

which indicates that when the function ∥Xw−∥₂² takes the minimum value, the corresponding value of w is the calculated model parameter, wherein y denotes the real price, X denotes a matrix of the various collected characteristic factors, and w is the final learned parameters and denotes the parameters of the model. It should be noted that w is a one-dimensional vector quantity, y is also a one-dimensional vector quantity (each value denotes one average value of the house), the subscript 2 denotes vector norm, and the norm 2 of the vector quantity refers to the square root of the sum of squares of each element in vector quantity. By using the machine learning algorithm to train the initialed appraisal model, when the function ∥Xw−y∥₂² takes the minimum value, the corresponding model parameter w is determined, wherein w=(β₀, β₁, β₂, . . . , βₙ). That is, determining the value of the model parameter w is to respectively determine values of β₀, β₁, β₂, . . . , βₙ.

Step 316, obtaining the real estate price appraisal model according to the model parameters determined.

In the present embodiment, after each model parameter is obtained by calculating according to the above described method, the real estate price appraisal model is obtained according to the model parameters determined.

In one embodiment, after model parameters are determined, the obtained model needs to be verified and evaluated. Evaluation standards include an average of absolute deviations, a variance of absolute deviations, a median of absolute deviations, R2 fraction, and so on. Only the model verified as qualified can be used to predict the corresponding real estate price, otherwise the corresponding model parameter needs to be regulated repeatedly until the model accords with the corresponding standards. More specifically,

the average of absolute deviations:

$$MAE ( y , \hat{y} ) = \frac{1}{{n}_{samples}} {\sum }_{i = 0}^{{n}_{samples} - 1} \vert {y}_{i} - {\hat{y}}_{i} \vert$$

the variance of absolute deviations:

$$MSE ( y , \hat{y} ) = \frac{1}{{n}_{samples}} {\sum }_{i = 0}^{{n}_{samples} - 1} {( {y}_{i} - {\hat{y}}_{i} )}^{2}$$

the median of absolute deviations:

MedAE(y,ŷ)=median(|y₁−ŷ₁|, . . . ,|yₙ−ŷₙ|)

R2 fraction:

$${R}^{2} ( y , \hat{y} ) = 1 - \frac{{\sum }_{i = 0}^{{n}_{samples} - 1} {( {y}_{i} - {\hat{y}}_{i} )}^{2}}{{\sum }_{i = 0}^{{n}_{samples} - 1} {( {y}_{i} - {\overline{y}}_{i} )}^{2}}$$

wherein:

$$\overline{y} = \frac{1}{{n}_{samples}} {\sum }_{i = 0}^{{n}_{samples} - 1} {y}_{i}$$

wherein nₛₐₘₚₗₑ denotes a number of all characteristics, yᵢ and ŷᵢ respectively denotes a real price of each real estate and an appraised price of each real estate calculated from the above described real estate appraisal model.

The above described different evaluation standards are used to verify and evaluate the model from different perspectives and describe confidence level of the chosen characteristics and model. In the evaluation standards, the average of absolute deviations reflects an overall deviation extent, however, the evaluations to extremely high prices and extremely low prices (such as prices of villa district and economy housing district) will be biased. In case that averages are basically equivalent to each other, the variance of absolute deviations is mainly used. Lower the variance, smaller the evaluation error. The median of absolute deviations reflects the deviation in most cases, however, the overall deviation may be great. The R2 fraction, also known as goodness of fit, reflects a difference between the predicted variance and the real variance. The nearer the R2 fraction approximates to 1, the more consistent the overall distribution categorical data where the categorical data comes from with the predicted distribution is.

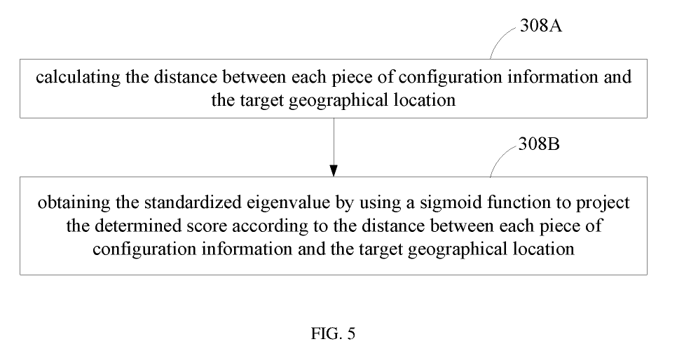

Referring to FIG. 5, in one embodiment, the Step 308 of obtaining a standardized eigenvalue by projecting the score determined according to a distance between a facility corresponding to each piece of configuration information and the target geographical location includes steps of:

Step 308A, calculating the distance between the facility corresponding to each piece of configuration information and the target geographical location;

Step 308B, obtaining the standardized eigenvalue by using the sigmoid function to project the score determined according to the distance between the facility corresponding to each piece of configuration information and the target geographical location.

In the present embodiment, after the score corresponding to each piece of configuration information is determined, the score needs to be standardized according to the preset rule, so as to facilitate the subsequent calculation. More specifically, the distance between the facility corresponding to each piece of configuration information and the target geographical location is calculated at first, and then the score determined is projected by using the sigmoid function according to the calculated distance to obtain the standardized eigenvalue. The standardized eigenvalue facilitates the subsequent evaluation to the housing price according to the previously established real estate price appraisal model. More specifically, the sigmoid function can be used as a coefficient factor of the distance:

$$coef = \frac{1}{1 + exp ( \frac{x - d \text{/} 2}{d \text{/} τ} )}$$

wherein x denotes the distance between the facility corresponding to the configuration information and the target geographical location, d denotes the preset distance range, such as d=1000 meters, and the attenuation degree of the coefficient factor with respect to the distance is decided by τ. Greater the τ, slower the attenuation. For example, τ=20. The score corresponding to the configuration information is projected through the above equation to obtain the standardized eigenvalue. That is, the score corresponding to the configuration information times the coefficient factor equals to the standardized eigenvalue corresponding to the configuration information.

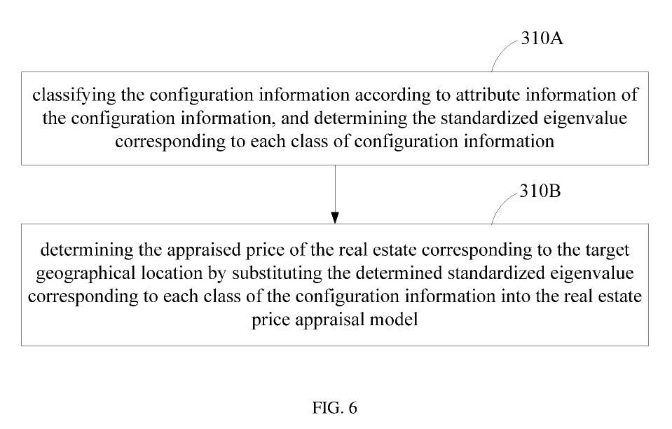

Referring to FIG. 6, in one embodiment, the Step 310 of determining an appraised price of the real estate corresponding to the target geographical location by using a real estate price appraisal model according to the standardized eigenvalue includes steps of:

Step 310A, classifying the configuration information according to the attribute information of the configuration information, and determining the standardized eigenvalue corresponding to each class of configuration information.

In the present embodiment, since multiple configuration information may be included around the real estate, if each piece of configuration information is used as one characteristic, not only confusion may occur, but the fitting is difficult when to establish the real estate price appraisal model due to multiple characteristics. Therefore, the configuration information can be classified according to the attribute information of the configuration information, one class of configuration information can be used as one characteristic, and the standardized eigenvalue corresponding to each class of configuration information can be determined. For example, the configuration information can be classified into various classes such as education, healthcare, transportation, tourism, commercial service, and life service. For example, schools such as primary schools and secondary schools are classified to education, hospitals such as Grade-A Tertiary hospital and Grade-A Secondary hospital are classified to healthcare, and commercial center factors and commercial food factors are classified to commercial service. In one embodiment, if two hospitals are located around the real estate, one is Grade-A Tertiary hospital whose eigenvalue is 3, another is Grade-A Secondary hospital whose eigenvalue is 2, then the eigenvalue corresponding to medical characteristics around the real estate is a sum of the two eigenvalues.

Step 310B, determining the appraised price of the real estate corresponding to the target geographical location by substituting the determined standardized eigenvalue corresponding to each class of the configuration information into the real estate price appraisal model.

In the present embodiment, after the configuration information is classified according to the attribute information, the eigenvalue determined corresponding to each class of the configuration information is substituted into the real estate price appraisal model. The corresponding real estate price is appraised by the real estate price appraisal model according to each input eigenvalue to obtain the appraised value of the real estate. Correspondingly, the training and learning of the real estate appraisal model proceeds after the classifying of the configuration information.

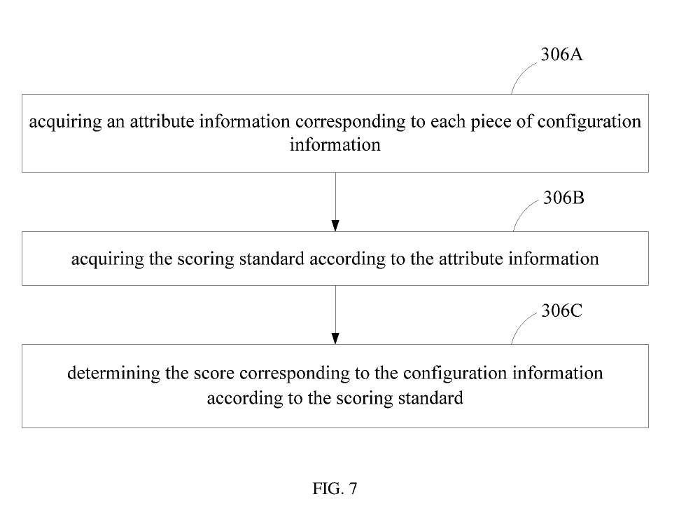

Referring to FIG. 7, in one embodiment, the Step 306 of determining a score corresponding to each piece of configuration information according to a preset scoring standard includes steps of:

Step 306A, acquiring the attribute information corresponding to each piece of configuration information.

In the present embodiment, the attribute information refers to the class of the obtained configuration facility around the real estate. For example, the corresponding attribute information of hospitals is healthcare, the corresponding attribute information of schools is education, the corresponding attribute information of shopping malls is commercial service, and the corresponding attribute information of supermarkets is life service. The purpose to obtain the corresponding attribute information of each piece of configuration information is to obtain the scoring standard corresponding to each piece of configuration information, because that different classes of the configuration information have different scoring standards. For example, schools are scored according to the rankings thereof, hospitals are scored according to the grades thereof, and supermarkets are scored according to the scales thereof.

Step 306B, acquiring the scoring standard according to the attribute information.

In the present embodiment, a corresponding relation between the attribute information and the scoring standard is previously stored. Therefore, after the attribute information corresponding to the scoring standard is acquired, the corresponding scoring standard can be found according to the acquired scoring standard. By setting the scoring standard, the influence extent of the configuration information to the real estate price is quantified, so that the real estate price can be subsequently evaluated according to the score determined.

Step 306C, determining the score corresponding to the configuration information according to the scoring standard.

In the present embodiment, after the scoring standard corresponding to the configuration information is acquired, the score corresponding to the configuration information can be calculated according to the scoring standard. More specifically, the characteristic of the configuration information is acquired to determine the corresponding score. For example, if the configuration information is a hospital, then the grade and the public praise of the hospital should be acquired, and the corresponding score could be determined according to the grade and the public praise. For example, when the hospital is a Grade-A Tertiary hospital whose score is 3, if the public praise of the hospital is great, then another point is added to the score; if the public praise of the hospital is just OK, then no more point is added to the score; if the public praise of the hospital is poor, then another point is subtracted from the score.

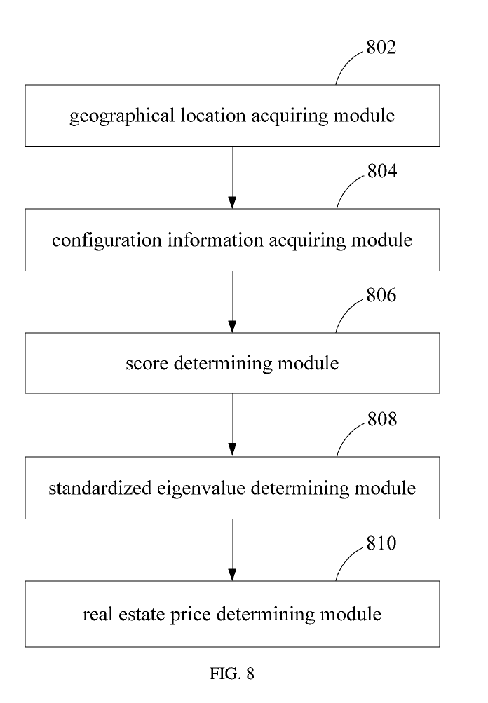

Referring to FIG. 8, in one embodiment, a device for processing real estate information is provided. The device includes:

a geographical location acquiring module 802, configured to acquire the target geographical location corresponding to the real estate information to be appraised;

a configuration information acquiring module 804, configured to acquire all configuration information within the preset range around the target geographical location;

a score determining module 806, configured to determine the score corresponding to each piece of configuration information according to the preset scoring standard;

a standardized eigenvalue determining module 808, configured to obtain the standardized eigenvalue by projecting the score determined according to the distance between the facility corresponding to each piece of configuration information and the target geographical location;

a real estate price determining module 810, configured to determine the appraised price of the real estate corresponding to the target geographical location by using the real estate price appraisal model according to the standardized eigenvalue.

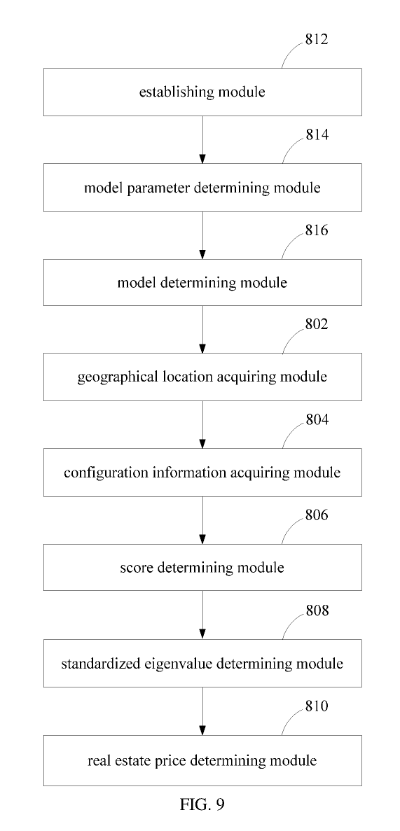

Referring to FIG. 9, in one embodiment, the device for processing the real estate information further includes:

an establishing module 812, configured to establish the initialized real estate price appraisal model;

a model parameter determining module 814, configured to determine the corresponding model parameters by training the initialized real estate price appraisal model according to collected prices of real estate and configuration information around the real estate;

a model determining module 816, configured to obtaining the real estate price appraisal model according to the determined model parameter.

In one embodiment, the standardized eigenvalue determining module 808 is further configured to calculate the distance between the facility corresponding to each piece of configuration information and the target geographical location; and obtain the standardized eigenvalue by using the sigmoid function to project the score determined according to the distance between each piece of configuration information and the target geographical location.

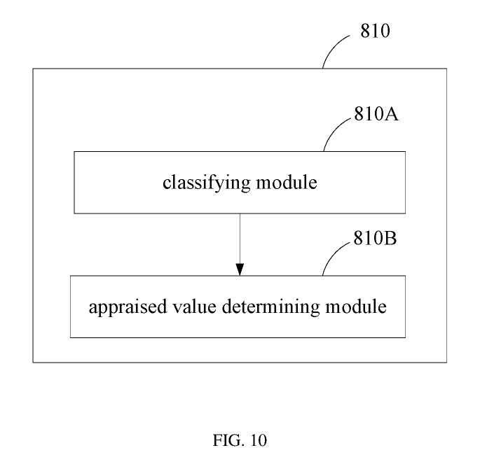

Referring to FIG. 10, in one embodiment, the real estate price determining module 810 includes:

a classifying module 810A, configured to classify the configuration information according to the attribute information of the configuration information and determine the standardized eigenvalue corresponding to each class of configuration information;

an appraised price determining module 810B, configured to determine the appraised price of the real estate corresponding to the target geographical location by substituting the determined standardized eigenvalue corresponding to each class of the configuration information into the real estate price appraisal model.

In one embodiment, the score determining module 806 is further configured to acquire the attribute information corresponding to each piece of configuration information, acquire the scoring standard corresponding to the attribute information, and determine the score corresponding to the configuration information according to the scoring standard.

Each module in the above described device for processing the real estate information can be implemented in whole or in part by software, hardware, and combinations thereof; wherein, the network interface can be an Ethernet card or a wireless network card and the like. Each module described above can be embedded in or independent from the processor in the server in the form of the hardware, or can be stored in the memory in the server in the form of the software, so that the processor calls the operations performed by each module described above. The processor can be a central processing unit (CPU), a microprocessor, a single chip, or the like.

In one embodiment, a computer device comprising a memory and a processor is provided. The memory stores computer readable instructions. When the computer readable instructions are executed by the processor, following steps are implemented: acquiring the target geographical location corresponding to the real estate information to be appraised; acquiring all configuration information within the preset range around the target geographical location; determining the score corresponding to each piece of configuration information according to the preset scoring standard; obtaining the standardized eigenvalue by projecting the score determined according to the distance between the facility corresponding to each piece of configuration information and the target geographical location; and determining the appraised price of the real estate corresponding to the target geographical location by using the real estate price appraisal model according to the standardized eigenvalue.

In one embodiment, before the step of acquiring the target geographical location corresponding to the real estate information to be appraised, when the computer readable instructions are executed by the processor, following steps are implemented: establishing the initialized real estate price appraisal model; determining the corresponding model parameters by training the initialized real estate price appraisal model according to collected prices of real estate and configuration information around the real estate; and obtaining the real estate price appraisal model according to the model parameters determined.

In one embodiment, the step of obtaining the standardized eigenvalue by projecting the score determined according to the distance between the facility corresponding to each piece of configuration information and the target geographical location includes steps of: calculating the distance between each piece of configuration information and the target geographical location; and obtaining the standardized eigenvalue by using the sigmoid function to project the score determined according to the distance between each piece of configuration information and the target geographical location.

In one embodiment, the step of determining the appraised price of the real estate corresponding to the target geographical location by using the real estate price appraisal model according to the standardized eigenvalue includes steps of: classifying the configuration information according to the attribute information of the configuration information and determining the standardized eigenvalue corresponding to each class of the configuration information; and determining the appraised price of the real estate corresponding to the target geographical location by substituting the determined standardized eigenvalue corresponding to each class of the configuration information into the real estate price appraisal model.

In one embodiment, the step of determining the score corresponding to each piece of configuration information according to the preset scoring standard includes steps of: acquiring the attribute information corresponding to each piece of configuration information; acquiring the scoring standard corresponding to the attribute information; and determining the score corresponding to the configuration information according to the scoring standard.

In one embodiment, one or more non-volatile computer readable storage media store the computer readable instructions. When the computer readable instructions are executed by one or more processors, following steps are implemented: acquiring the target geographical location corresponding to the real estate information to be appraised; acquiring all configuration information within the preset range around the target geographical location; determining the score corresponding to each piece of configuration information according to the preset scoring standard; obtaining the standardized eigenvalue by projecting the score determined according to the distance between the facility corresponding to each piece of configuration information and the target geographical location; and determining the appraised price of the real estate corresponding to the target geographical location by using the real estate price appraisal model according to the standardized eigenvalue.

In one embodiment, before the step of acquiring the target geographical location corresponding to the real estate information to be appraised, when the computer readable instructions are executed by the one or more processors, following steps are further implemented: establishing the initialized real estate price appraisal model; determining the corresponding model parameters by training the initialized real estate price appraisal model according to collected prices of real estate and collected configuration information around the real estate; and obtaining the real estate price appraisal model according to the model parameters determined.

In one embodiment, the step of obtaining the standardized eigenvalue by projecting the score determined according to the distance between each piece of configuration information and the target geographical location includes steps of: calculating the distance between the facility corresponding to each piece of configuration information and the target geographical location; and obtaining the standardized eigenvalue by using the sigmoid function to project the score determined according to the distance between each piece of configuration information and the target geographical location.

In one embodiment, the step of determining the appraised price of the real estate corresponding to the target geographical location by using the real estate price appraisal model according to the standardized eigenvalue includes steps of: classifying the configuration information according to the attribute information of the configuration information and determining the standardized eigenvalue corresponding to each class of the configuration information; and determining the appraised price of the real estate corresponding to the target geographical location by substituting the determined standardized eigenvalue corresponding to each class of the configuration information into the real estate price appraisal model.

In one embodiment, the step of determining the score corresponding to each piece of configuration information according to the preset scoring standard includes steps of: acquiring the attribute information corresponding to each piece of configuration information; acquiring the scoring standard corresponding to the attribute information; and determining the score corresponding to the configuration information according to the scoring standard.

It should be noted that those skilled in the art will appreciate that all or part of the steps in the method according to the above embodiments can be implemented by related hardwares under instructions of a program, which is stored in a computer readable storage medium, and when the program is implemented, the steps in the method according to the above embodiments can be included. Wherein the storage medium may be a magnetic disk, optical disk, read-only memory (ROM), random access memory (RAM), or the like.

The technical characters of the above-described embodiments can be arbitrarily combined. In order to make the description simple, not all possible combinations of the technical characters in the above embodiments are described. However, as long as there is no contradiction in the combination of these technical characters, the combinations should be in the scope of the present disclosure.

The foregoing embodiments only describe several implementation manners of the present invention, and their description is specific and detailed, but cannot therefore be understood as a limitation to the patent scope of the present disclosure. It should be noted that a person of ordinary skill in the art may further make variations and improvements without departing from the conception of the present disclosure, and these all fall within the protection scope of the present disclosure. Therefore, the patent protection scope of the present disclosure should be subject to the appended claims.

1. A method for processing real estate information, comprising:
acquiring a target geographical location corresponding to real estate information to be appraised;
acquiring all configuration information within a preset range around the target geographical location;
determining a score corresponding to each piece of configuration information according to a preset scoring standard;
obtaining a standardized eigenvalue by projecting the score determined according to a distance between a facility corresponding to each piece of configuration information and the target geographical location; and
determining an appraised price of a real estate corresponding to the target geographical location by using a real estate price appraisal model according to the standardized eigenvalue.

2. The method of claim 1, before acquiring a target geographical location corresponding to real estate information to be appraised, further comprising:
establishing an initialized real estate price appraisal model;
determining corresponding model parameters by training the initialized real estate price appraisal model according to collected prices of real estate and configuration information around the real estate; and
obtaining the real estate price appraisal model according to the model parameters determined.

3. The method of claim 1, wherein obtaining a standardized eigenvalue by projecting the score determined according to a distance between a facility corresponding to each piece of configuration information and the target geographical location comprises:
calculating the distance between the facility corresponding to each piece of configuration information and the target geographical location; and
obtaining the standardized eigenvalue by using a sigmoid function to project the score determined according to the distance between the facility corresponding to each piece of configuration information and the target geographical location.

4. The method of claim 1, wherein determining an appraised price of a real estate corresponding to the target geographical location by using a real estate price appraisal model according to the standardized eigenvalue comprises:
classifying the configuration information according to attribute information of the configuration information, and determining a standardized eigenvalue corresponding to each class of configuration information; and
determining the appraised price of the real estate corresponding to the target geographical location by substituting the standardized eigenvalue determined corresponding to each class of configuration information into the real estate price appraisal model.

5. The method of claim 1, wherein determining a score corresponding to each piece of configuration information according to a preset scoring standard comprises steps of:
acquiring attribute information corresponding to each piece of configuration information;
acquiring the scoring standard according to the attribute information; and
determining the score corresponding to the configuration information according to the scoring standard.

6-10. (canceled)

11. A computer device, comprising a memory and a processor, wherein the memory has computer readable instructions stored thereon, when the computer readable instructions are executed by the processor, at least the following acts are implemented:
acquiring a target geographical location corresponding to the real estate information to be appraised;
acquiring all configuration information within a preset range around the target geographical location;
determining a score corresponding to each piece of configuration information according to a preset scoring standard;
obtaining a standardized eigenvalue by projecting the score determined according to a distance between a facility corresponding to each piece of configuration information and the target geographical location; and
determining an appraised price of a real estate corresponding to the target geographical location by using a real estate price appraisal model according to the standardized eigenvalue.

12. The computer device of claim 11, wherein, before acquiring a target geographical location corresponding to the real estate information to be appraised, at least the following acts are implemented:
establishing an initialized real estate price appraisal model;
determining corresponding model parameters by training the initialized real estate price appraisal model according to collected prices of real estate and configuration information around the real estate; and
obtaining the real estate price appraisal model according to the model parameters determined.

13. The computer device of claim 11, wherein obtaining a standardized eigenvalue by projecting the score determined according to a distance between a facility corresponding to each piece of configuration information and the target geographical location comprises:
calculating the distance between the facility corresponding to each piece of configuration information and the target geographical location; and
obtaining the standardized eigenvalue by using a sigmoid function to project the score determined according to the distance between the facility corresponding to each piece of configuration information and the target geographical location.

14. The computer device of claim 11, wherein determining an appraised price of a real estate corresponding to the target geographical location by using a real estate price appraisal model according to the standardized eigenvalue comprises:
classifying the configuration information according to attribute information of the configuration information and determining the standardized eigenvalue corresponding to each class of configuration information; and
determining the appraised price of the real estate corresponding to the target geographical location by substituting the determined standardized eigenvalue corresponding to each class of the configuration information into the real estate price appraisal model.

15. The computer device of claim 11, wherein determining a score corresponding to each piece of configuration information according to a preset scoring standard comprises:
acquiring attribute information corresponding to each piece of configuration information;
acquiring the scoring standard according to the attribute information; and
determining the score corresponding to the configuration information according to the scoring standard.

16. One or more non-volatile computer readable storage media, having computer readable instructions stored thereon, wherein when the computer readable instructions are executed by one or more processors, at least the following acts are implemented:
acquiring a target geographical location corresponding to the real estate information to be appraised;
acquiring all configuration information within a preset range around the target geographical location;
determining a score corresponding to each piece of configuration information according to a preset scoring standard;
obtaining a standardized eigenvalue by projecting the score determined according to a distance between a facility corresponding to each piece of configuration information and the target geographical location; and
determining an appraised price of a real estate corresponding to the target geographical location by using a real estate price appraisal model according to the standardized eigenvalue.

17. The non-volatile computer readable storage media of claim 16, wherein before acquiring a target geographical location corresponding to the real estate information to be appraised, at least the following acts are implemented:
establishing an initialized real estate price appraisal model;
determining corresponding model parameters by training the initialized real estate price appraisal model according to collected prices of real estate and configuration information around the real estate; and
obtaining the real estate price appraisal model according to the model parameters determined.

18. The computer device of claim 16, wherein obtaining a standardized eigenvalue by projecting the score determined according to a distance between a facility corresponding to each piece of configuration information and the target geographical location comprises:
calculating the distance between the facility corresponding to each piece of configuration information and the target geographical location; and
obtaining the standardized eigenvalue by using a sigmoid function to project the score determined according to the distance between the facility corresponding to each piece of configuration information and the target geographical location.

19. The computer device of claim 16, wherein determining an appraised price of a real estate corresponding to the target geographical location by using a real estate price appraisal model according to the standardized eigenvalue comprises:
classifying the configuration information according to attribute information of the configuration information and determining the standardized eigenvalue corresponding to each class of configuration information; and
determining the appraised price of the real estate corresponding to the target geographical location by substituting the determined standardized eigenvalue corresponding to each class of the configuration information into the real estate price appraisal model.

20. The computer device of claim 16, wherein determining a score corresponding to each piece of configuration information according to a preset scoring standard comprises:
acquiring attribute information corresponding to each piece of configuration information;
acquiring the scoring standard according to the attribute information; and
determining the score corresponding to the configuration information according to the scoring standard.
